(19) United States
(12) Patent Application Publication
(10) Pub. No.: US 2010/0321563 A1
(43) Pub. Date: Dec. 23, 2010

(54) SOLID-STATE IMAGING UNIT

(75) Inventor: Tomomi KUME, Kanagawa (JP)

Correspondence Address: ROBERT J. DEPKE;LEWIS T. STEADMAN, ROCKEY, DEPKE & LYONS, LLC, SUITE 5450 SEARS TOWER, CHICAGO, IL, 60606-6306, US

(73) Assignee: SONY CORPORATION, Minato-ku (JP)

(21) Appl. No.: 12/789,099

(22) Filed: May 27, 2010

(30) Foreign Application Priority Data
Jun. 23, 2009 (JP) 2009-148797
Sep. 18, 2009 (JP) 2009-217717

(51) Int. Cl. H04N 5/225

(52) U.S. Cl. 348/374; 348/E05.091

(57) ABSTRACT

A solid-state imaging unit includes: an imaging device receiving light at a light-receiving surface thereof; and a protective component having a light transmissive member covering the light-receiving surface of the imaging device and a frame securing the light transmissive member at the periphery thereof, the protective component being mounted on a peripheral region of the light-receiving surface of the imaging device, wherein at least the frame is formed using a molding process.

The present application claims priority to Japanese Patent Applications JP 2009-148797 and 2009-217717 filed in the Japanese Patent Office on Jun. 23, 2009 and Sep. 18, 2009, respectively, the entire contents of which is hereby incorporated by reference.

### BACKGROUND OF THE INVENTION

1. Field of the Invention

The present invention relates to a solid-state imaging unit and, more particularly, to a solid-state imaging unit in which the influence of particles can be suppressed.

2. Description of the Related Art

Solid-state imaging units such as CCDs (charge-coupled devices) and CMOS (complementary metal oxide semiconductor) sensors, which are semiconductor devices, have already been put in practical use in various fields.

A light-receiving surface of a solid-state imaging unit has irregularities which are attributable to, for example, a micro lens provided at each pixel of the device. In general, a solid-state imaging unit has a configuration in which a lid having transmissive properties made of glass or the like is provided to protect the light-receiving surface thereof by preventing deposition of foreign substances on the light-receiving surface.

FIGS. 1A and 1B show a solid-state imaging unit according to the related art. FIG. 1A is a plan view of the solid-state imaging unit, and FIG. 1B is a side view of the solid-state imaging unit.

As shown in FIGS. 1A and 1B, in a solid-state imaging unit 11, in order to protect a light-receiving surface of an imaging device 12 having a plurality of pixels disposed to receive light, ribs 13 are formed on a substrate of the imaging device 12 using an exposure process or dispensing or printing a material on the surface, and a seal glass 14 is placed on the ribs 13. The device therefore has a hollow structure formed by the gap between the light-receiving surface of the imaging device 12 and the seal glass 14.

For example, JP-A-2006-5025 (Patent Document 1) discloses a technique for bonding a lid to a semiconductor wafer utilizing properties of a photo-curing adhesive (photosensitive adhesive) and a heat-curing adhesive. JP-A-2007-165656 (Patent Document 2) discloses a technique for achieving parallelism between a plane perpendicular to an optical axis of an imaging lens and an imaging surface of a solid-state imaging unit with high accuracy.

### SUMMARY OF THE INVENTION

In the solid-state imaging unit according to the related art, since the ribs for supporting the seal glass is formed using an exposure process or the like utilizing a photo-curing adhesive, the ribs can be provided with a height as small as several tens and it is therefore difficult to keep the gap between the light-receiving surface of the imaging device and the seal glass wide enough. As a result, in the solid-state imaging unit according to the related art, the seal glass is in proximity to the light-receiving surface of the imaging device. Therefore, the device is excessively affected by particles (dust) or scratches on the seal glass, which can result in, for example, a shadow on an image obtained by the device.

Under such circumstances, it is desirable to provide measures to allow the influence of particles to be suppressed.

According to an embodiment of the invention, there is provided a solid-state imaging unit including an imaging device receiving light at a light-receiving surface thereof and a protective component having a light transmissive member covering the light-receiving surface of the imaging device and a frame securing the light transmissive member at the periphery thereof. The protective component is mounted on a peripheral region of the light-receiving surface of the imaging device, and at least the frame is formed using a molding process.

In the embodiment of the invention, the protective component mounted on a peripheral region of the light-receiving surface of the imaging device includes a light transmissive member covering the light-receiving surface of the imaging device and a frame securing the transparent body at the periphery thereof, and at least the frame is formed by a molding process.

The embodiment of the invention allows the influence of particles to be suppressed.

### BRIEF DESCRIPTION OF THE DRAWINGS

FIGS. 1A and 1B are illustrations of a solid-state imaging unit according to the related art;

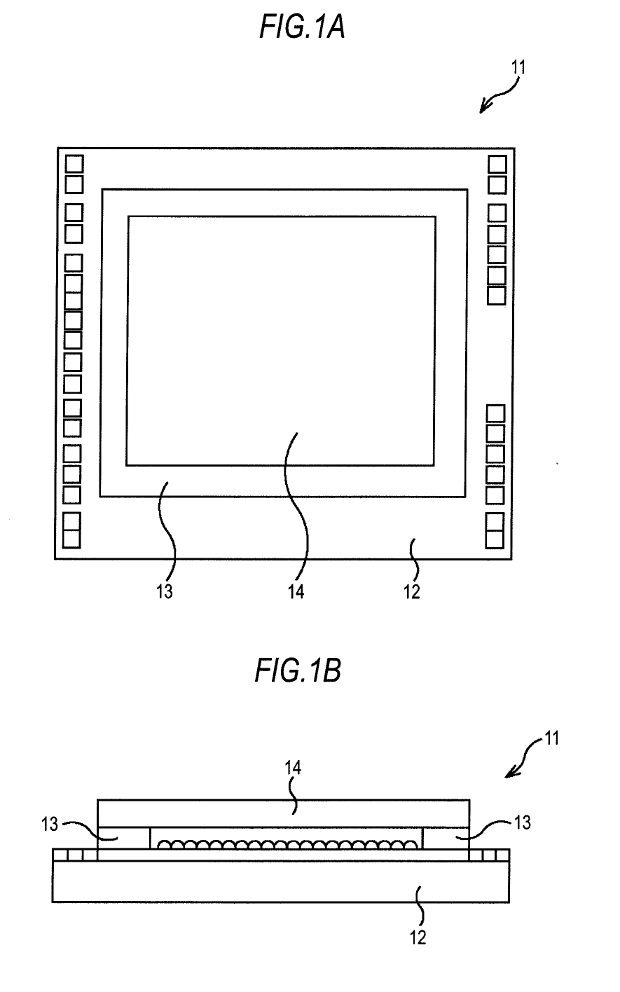

FIGS. 2A and 2B are illustrations showing an exemplary configuration of an embodiment of a solid-state imaging unit according to an embodiment of the invention;

FIG. 3 is illustrations for explaining a protective component bonded to a surface of an imaging device;

FIG. 4 is a flow chart for explaining processes for manufacturing the solid-state imaging unit;

FIGS. 5A to 5E are illustrations for explaining processes for manufacturing the solid-state imaging unit;

FIG. 6 is illustrations showing another exemplary configuration of a protective component provided in the solid-state imaging unit;

FIG. 7 is a side view of the solid-state imaging unit which is shown along with a lens barrel mounted thereon;

FIG. 8 is illustrations showing still another exemplary configuration of a protective component provided in the solid-state imaging unit; and

FIGS. 9A to 9C are illustrations of other exemplary configurations of the solid-state imaging unit.

### DESCRIPTION OF PREFERRED EMBODIMENTS

A specific embodiment of the invention will now be described in detail with reference to the drawings.

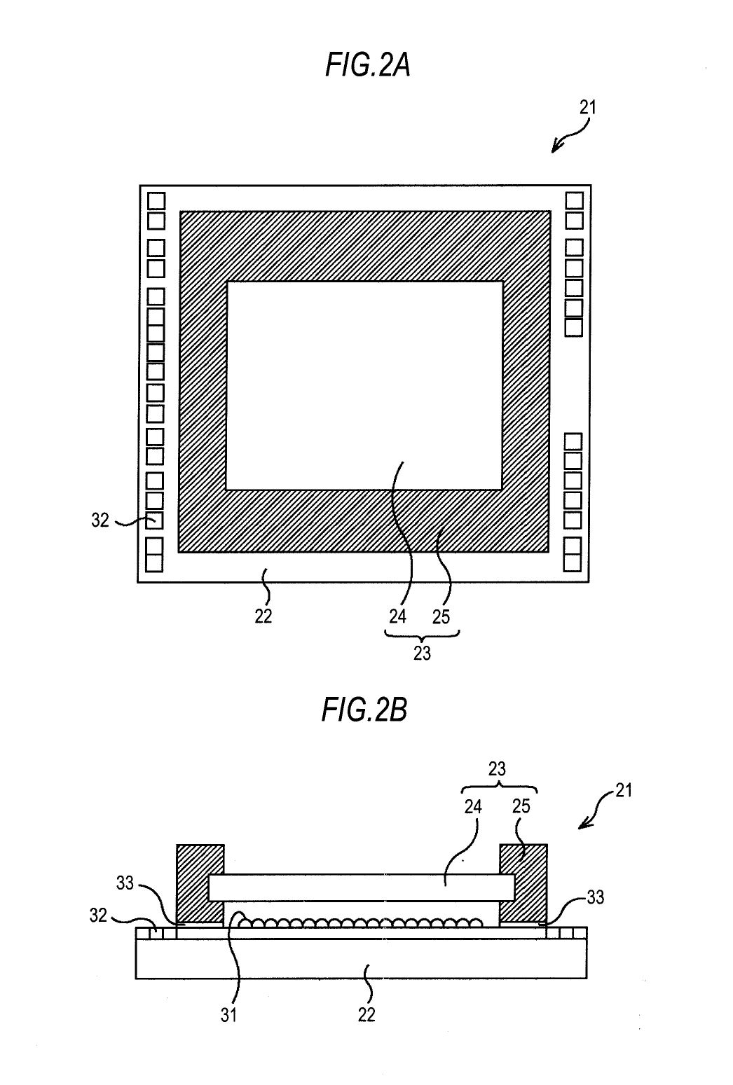

FIGS. 2A and 2B show an exemplary configuration of an embodiment of a solid-state imaging unit according to the invention. FIG. 2A is a plan view of the solid-state imaging unit, and FIG. 2B is a side view of the solid-state imaging unit.

Referring to FIGS. 2A and 2B, a solid-state imaging unit 21 includes an imaging device 22 and a protective component 23, and the protective component 23, which is provided by integrally molding a seal glass 24 and a molded resin 25, is directly mount on the imaging device 22.

In a central region of a surface (the top surface on FIG. 2B) of the imaging device 22 which may be a CCD or a CMOS sensor, a plurality of pixels receiving light rays are arranged to form a light-receiving surface, and a micro lens 31 is disposed at each pixel of the light-receiving surface. A plurality of terminals 32 for outputting electric signal output from the pixels out of the device are provided in peripheral regions of the surface of the imaging device 22.

The protective component 23 is a component for protecting a light-receiving region of the imaging device 22, and the component is formed by integrally molding a seal glass 24 which is a piece of translucent material and a molded resin 25 which is a frame for securing the seal glass 24 to the element at the periphery of the same. For example, a black resin is used as the molded resin 25, and the molded resin 25 therefore has light-blocking properties.

The protective component 23 is bonded to the surface of the imaging device 22 using an adhesive 33.

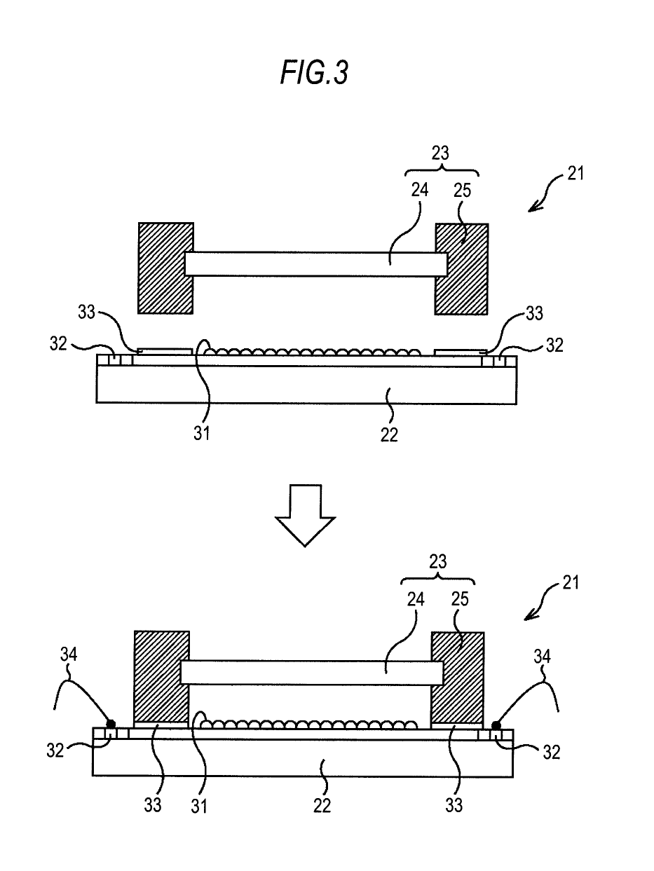

For example, the adhesive 33 is applied to a peripheral region which has the same width as the width of a bottom surface of the molded resin 25 and which is located outside the light-receiving surface of the imaging device 22 (the region where the micro lenses 31 are provided) and located inside the plurality of terminals 32, as shown in FIG. 3. For example, a heat-curing adhesive including epoxy resin is used as the adhesive 33, and the adhesive 22 is applied to such a thickness that irregularities on the surface of the imaging device 22 are cleared. A photo-curing adhesive may alternatively be used as the adhesive 33.

The molded resin 25 is then placed on the surface having the adhesive 33 applied thereon, and a curing process for curing the adhesive 33 is thereafter carried out to bond the protective component 23 to the surface of the imaging device 22. Wires 34 for supplying electric signals output from the pixels of the imaging device 22 to an external apparatus are wire-bonded to respective ones of the plurality of terminals 32 formed at the periphery of the surface of the imaging device 22.

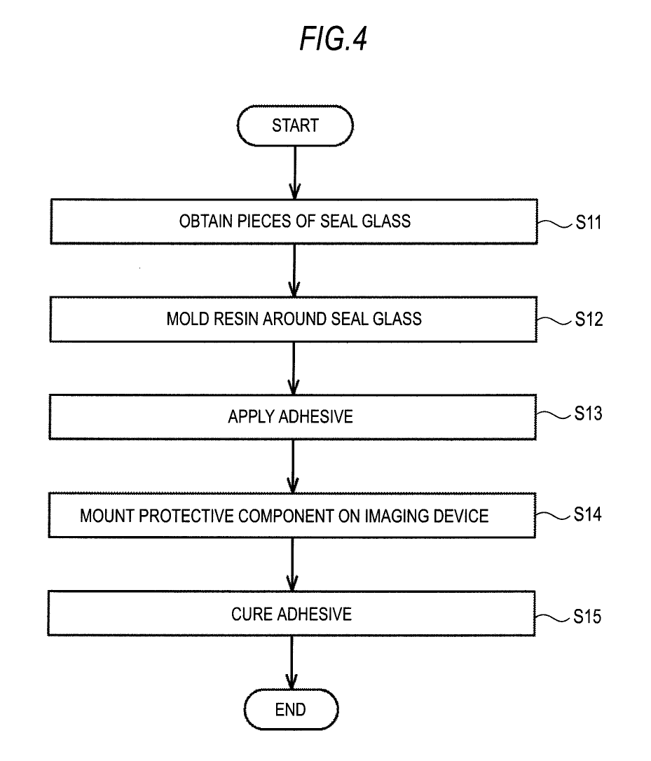

Processes for manufacturing the solid-state imaging unit 21 will now be described with reference to the flow chart in FIG. 4.

At step S11, a glass dicing process is performed to dice a glass substrate into pieces of seal glass 24.

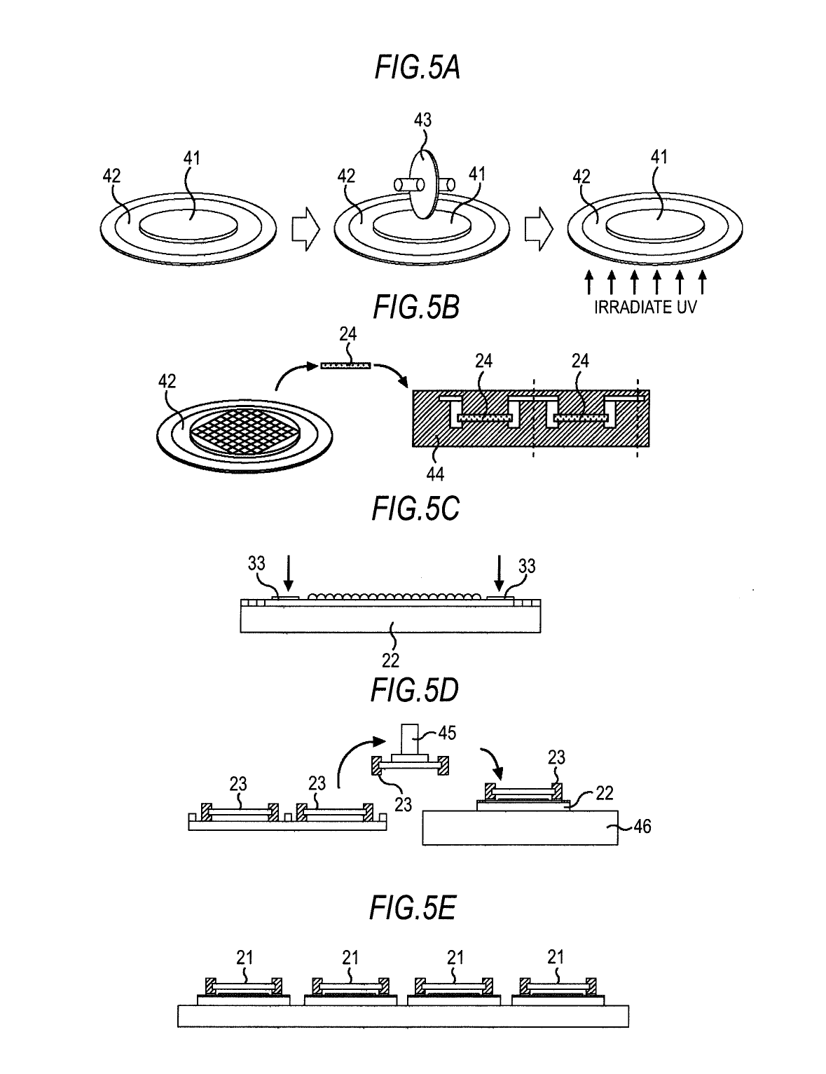

For example, a glass substrate 41 is mounted on a frame 42 using a dicing tape which is bonded to a bottom surface of the glass substrate 41, as shown in FIG. 5A. The glass substrate 41 is cut by rotating a glass dicer 43, which is a circular rotating blade made of diamond, at a high speed while cooling the substrate using ultrapure water. Thereafter, the dicing tape is irradiated with ultraviolet rays from a UV (ultraviolet) irradiator to remove the tape, whereby the seal glass 24 is separated into pieces.

When dicing the seal glass 24, an appropriate method may be selected from among various cutting methods, e.g., cutting the seal glass so as to form fully vertical side surfaces (full cut) or cutting the seal glass so as to form side surfaces chamfered on one side or both sides thereof (bevel cut), the selection being made in consideration to the rigidity of the glass, stress generated when the molded resin 25 is cured, stress generated after the glass is bonded to the imaging device 22, and the number of processes. The chamfering process may be C chamfering for cutting the glass at an angle of 45 deg or R chamfering for cutting the glass with predetermined curvature.

At step S12, a molding process is performed to obtain protective components 23 by molding (injection molding) a resin around the seal glasses 24.

For example, as shown in FIG. 5B, the seal glasses 24 obtaining by dicing are removed from the frame 42 and set in a die 44 for molding a resin to obtain the molded resin 25. Thereafter, a resin softened by heating to a predetermined temperature is injected to fill the die 44, and the resin is molded around the seal glasses 24. The resin injected into the die 44 is solidified to become molded resin 25 to, whereby protective components 23 are provided.

At step S13, an adhesive applying process is performed to apply an adhesive 33 to a surface of each imaging device 22.

For example, the adhesive 33 is applied to a surface of the imaging device 22 as shown in FIG. 5C. Methods for applying the adhesive 33 include the use of a dispenser for accurately supplying a predetermined amount of liquid adhesive and a printing process for transferring an adhesive using a relief pattern. The adhesive 33 may be applied to the imaging devices 22 when the elements are still in the form of a wafer, and the adhesive 33 may alternatively be applied to the individual imaging devices 22 after dicing the wafer.

At step S14, a bonding process is performed to mount a protective component 23 on a surface of each imaging device 22.

For example, as shown in FIG. 5D, a protective component 23 removed from the die 44 is accurately mounted on a surface of an imaging device 22 using a chip tray glass bonder 45. For example, the process of mounting a protective component 23 on an imaging device 22 may be carried out in such an environment that the temperature of a stage 46 on which the imaging device 22 is placed or the temperature of the chip tray glass bonder 45 transporting the protective component 23 is kept higher than an ordinary temperature. By keeping the temperature of the state 46 or the chip tray glass bonder 45 higher than an ordinary temperature as thus described, the protective component 23 can be preliminarily secured on the imaging device 22 by placing the protective component 23 on a surface of the imaging device 22. The process of mounting the protective component 23 on the imaging device 22 may alternatively be carried out at an ordinary temperature.

At step S15, a curing process for curing the adhesive 33 is performed.

For example, as shown in FIG. 5E, a plurality of solid-state imaging units 21 are heated in, for example, in a curing oven to cure the adhesive 33, whereby the protective components 23 are secured on surfaces of the imaging devices 22.

At the curing process, since a solid-state imaging unit 21 is put in an environment at a high temperature, the pressure in the space between the surface of the imaging device 22 and the protective component (the internal pressure of the cavity) increases, which can cause the protective component 23 to come off the imaging device 22. Measures taken to avoid such an adverse effect of an increase in the internal pressure include heating the solid-state imaging units 21 in a pressurized oven, the use of a fixing jig for fixing the protective component 23, and performing stepwise curing to increase the temperature stepwise.

The molded resin 25 for securing the seal glass 24 at the periphery thereof can be designed to have an arbitrary height by providing the molded resin 25 using a molding process as described above, and the gap between the light-receiving surface of the imaging device 22 and the seal glass 24 can be kept greater than that in the related art. Thus, the influence of particles on the seal glass 24 can be suppressed, and it is therefore possible, for example, to prevent the generation of shadows on an image obtained by imaging device 22.

In the case of a solid-state imaging unit according to the related art, since a seal glass is located close to a light-receiving surface of an imaging device, the device can be excessively affected by particles. In general, the influence of particles can be avoided by increasing the gap between the light-receiving surface of the imaging device and the seal glass. In the solid-state imaging unit 21, the molded resin 25 is designed to support the seal glass 24 at such a height that the influence of particles can be avoided, whereby the influence of particle on the seal glass 24 can be suppressed.

Since a black resin is used as the molded resin 25, the molded resin 25 can be provided with light-blocking properties, which makes it possible to prevent reflected light or scattered light from impinging on the light-receiving surface of the imaging device 22 sideways. By preventing reflected light or scattered light from entering the element sideways as thus described, it is possible to prevent flare or ghost from being generated on an image obtained by the imaging device 22.

In a solid-state imaging unit according to the related art, a seal glass is secured on an imaging device using, for example, a photo-curing adhesive, and it is difficult to provide the photo-curing adhesive with light-blocking properties because such an adhesive is required to have translucency. Therefore, reflected light or scattered light can enter the imaging device sideways through the photo-curing adhesive after the adhesive is cured. On the contrary, the molded resin 25 for securing the seal glass 24 of the solid-state imaging unit 21 is provided using a molding process, and light-blocking properties can therefore be easily provided by employing a block resin as the molded resin.

In the case of the solid-state imaging unit 21, molding is carried out such that the seal glass 24 is sandwiched by the molded resin 25 on top and bottom surfaces thereof, the seal glass 24 is therefore reinforced by the molded resin 25. Thus, the seal glass 24 can be made less vulnerable to distortion.

The use of an epoxy type resin material as the molded resin 25 makes it possible to satisfy requirements on physical properties of the member such as heat resistance and reliability requirements on the member such as anti-corrosion properties against impurities. The use of ribs formed by an exposure process can result in the problem of dew formation and the problem of adverse effects exerted on the light-receiving surface by an additive such as a filler. The use of the molded resin 25 provided by a molding process allows such problems to be avoided.

Optical components such as lenses made of resin or glass or various types of optical filters such as infrared cut filters (IRCF) and optical low pass filters (OLPF) may alternatively be used as the seal glass 24. The use of such an alterative component allows the solid-state imaging unit 21 to be provided with a small size and optical characteristics of the alternative component.

The solid-state imaging unit 21 may alternatively employ a protective component having, for example, a mounting section on which another component can be mounted.

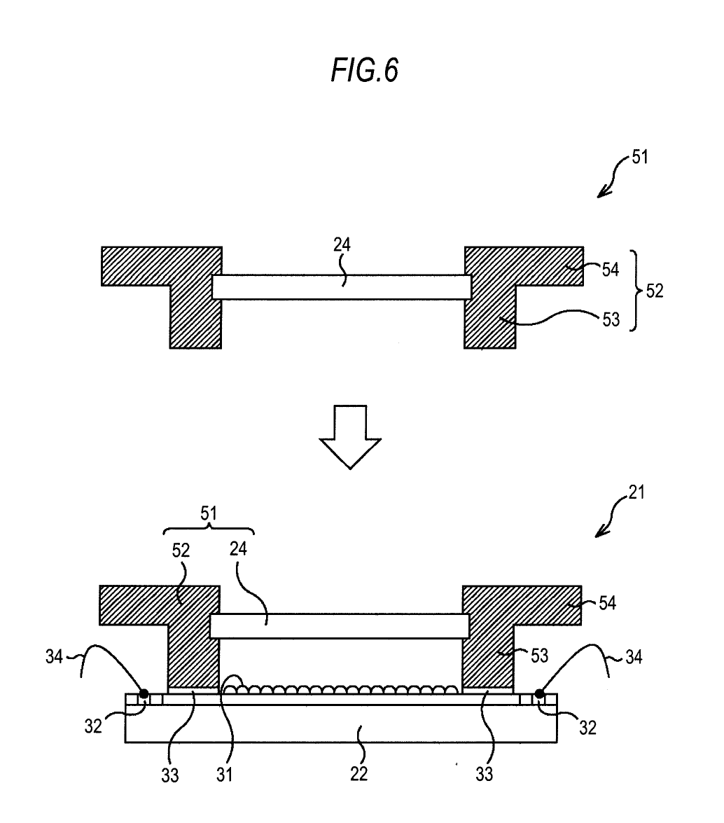

FIG. 6 shows another exemplary configuration of a protective component included in the solid-state imaging unit 21.

As shown in FIG. 6, a molded resin 52 of a protective component 51 includes a frame 53 formed with a width similar to the width of the molded resin 25 shown in FIG. 3 and a mounting section 54 formed with a width greater than that of the frame 53. Since the mounting section 54 is formed with a predetermined width such that the section extends outward from the frame 53, the periphery of the seal glass 24 can be secured by the molded resin 52, and another component can be mounted on the mounting section 54.

For example, the molded resin 52 may be provided using a die having a sectional shape as shown in FIG. 6. Alternatively, the molded resin 52 may be provided by forming a frame having a width equivalent to the combined width of the frame 53 and the mounting section 54 and thereafter cutting a lower part of the frame having a great width from outside until that width of the lower part of the frame equals the width of the frame 53. Since the frame 53 has a width smaller than that of the mounting section 54, spaces can be left as shown in the lower part of FIG. 6 to allow the wires 34 to be bonded to the terminals 32 formed at the periphery of the surface of the imaging device 22.

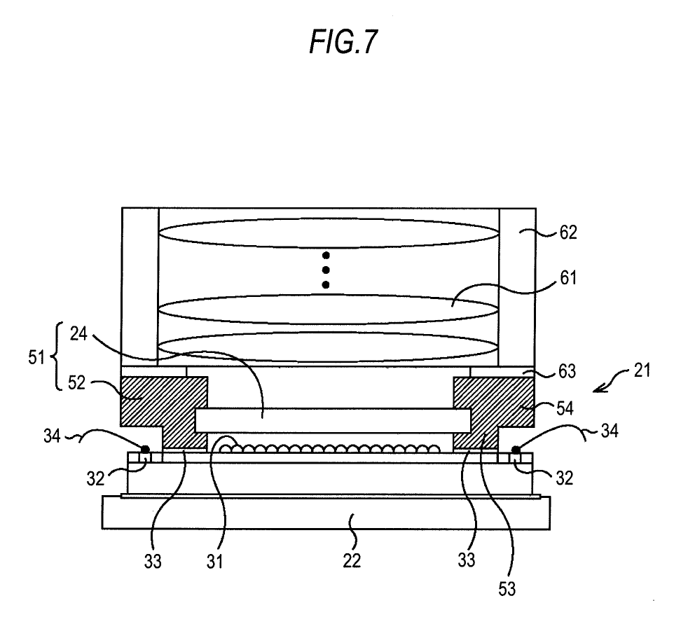

FIG. 7 is a side view of the solid-state imaging unit 21 which is shown along with a lens barrel 62 mounted thereon.

The lens barrel 62 contains a plurality of lenses 61, and it is bonded and secured to a top surface of the mounting section 54 of the protective component 51 secured on the surface of the solid-state imaging unit 21 using an adhesive 63.

As illustrated, since the protective component 51 includes the mounting section 54 having an increased width, an additional component such as the lens barrel 62 can be mounted on the imaging device 22 through the protective component 51.

Since the molded resin 52 is provided using a molding process like the molded resin 25, it can be processed with higher accuracy compared to, for example, resin ribs formed using an exposure process. As a result, the top surface of the mounting section 54 for mounting the lens barrel 62 can be accurately finished to achieve a high degree of parallelism. Thus, the optical axis of the lens barrel 62 can be set with high accuracy (tilt accuracy) relative to the light-receiving surface of the imaging device 22. That is, the lens barrel 62 can be accurately positioned relative to the imaging device 22, and the lens barrel 62 can therefore be mounted without a need for adjustment of the axis thereof.

Since the lens barrel 62 is directly mounted on the protective component 51, the solid-state imaging unit 21 can be made compact. As a result, for example, improved freedom can be provided in designing outline specifications of the lens and in designing a back focal distance of the same.

The adhesive 33 for bonding the protective component 51 to the imaging device 22 maybe applied to a thickness greater than the thickness required to clear irregularities on the surface of the imaging device 22. For example, the adhesive may have such a thickness that parallelism can be maintained between the lens barrel 62 and the light-receiving surface of the imaging device 22.

For example, the solid-state imaging unit 21 may employ an integrated protective component including a transparent resin obtained by using the so-called two-color molding. In the protective component 23 shown in FIG. 3, the molded resin 25 is provided by molding a resin so as to secure the seal glass 24. Therefore, the protective component is a combination of the seal glass 24 and the molded resin 25 which are independent components. The protective component can alternatively be produced as a single component by using a transparent resin instead of the seal glass 24.

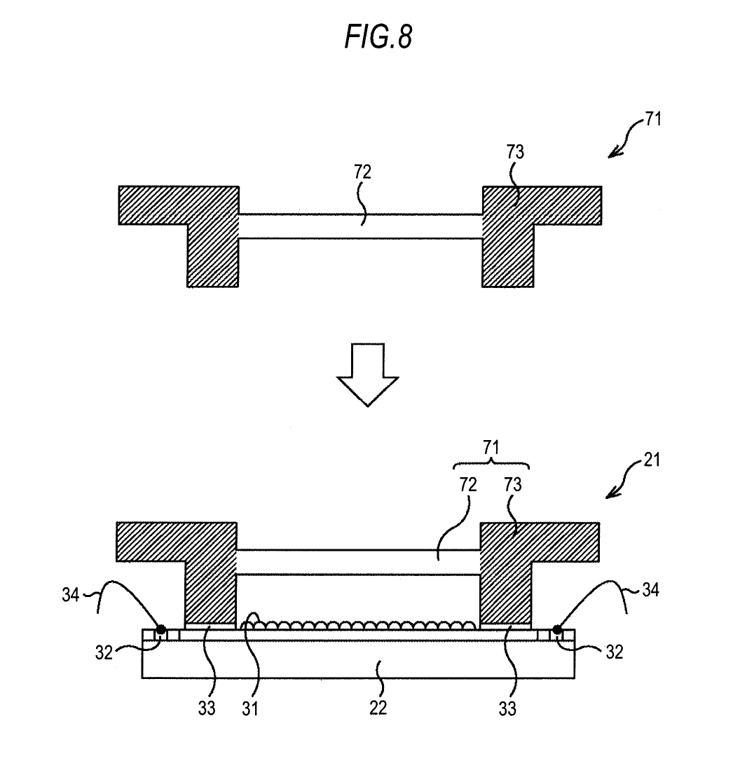

FIG. 8 shows still another exemplary configuration of the protective component provided in the solid-state imaging unit 21.

A protective component 71 shown in FIG. 8 is formed at a time by a molding process for molding a transparent resin into a light transmissive member 72 and molding a frame 73 around the light transmissive member 72. For example, at a step for pouring resins into a die for molding the protective component 71, a transparent resin is injected into a part of the die corresponding to the light transmissive member 72 of the protective component 71, and a black resin is injected into a part of the die corresponding to the frame 73. At this time, the two-color molding is carried out by controlling the speed of injection of each resin appropriately to inject the transparent resin and the black resin into the respective parts.

By molding the light transmissive member 72 and the frame 73 at a time as thus described, the step of fabricating the protective component 71 can be performed in a shorter time when compared to, for example, the step of fabricating the protective component 23 shown in FIG. 3, and a cost reduction can therefore be achieved.

While the solid state imaging devices 21 shown in FIGS. 3, 5 and 8 are connected to an external apparatus using wire bonding, the protective components may be mounted, for example, in solid-state imaging units which are connected to an external apparatus using bottom wiring utilizing through holes.

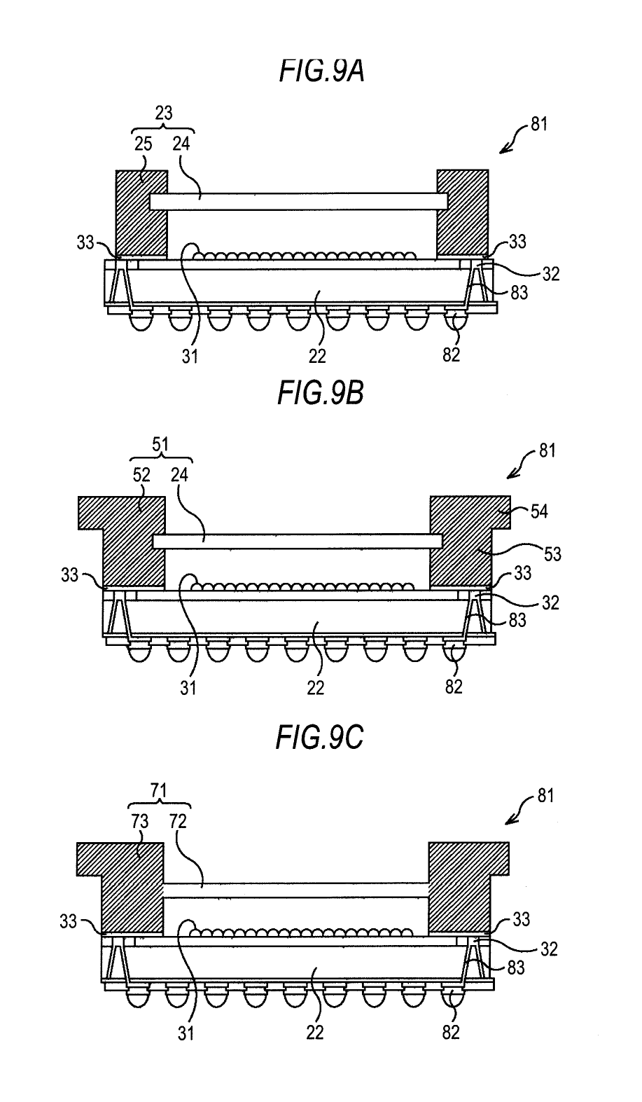

FIGS. 9A, 9B, and 9C are illustrations showing another exemplary configuration of a solid-state imaging unit.

In a solid-state imaging unit 81 shown in FIGS. 9A to 9C, wirings 82 for supplying electrical signals output from pixels of an imaging device 22 to an external apparatus are formed on a bottom surface of the imaging device 22 opposite to a top surface of the same (a surface including a light-receiving surface formed thereon). The wirings 82 on the bottom surface are electrically connected to a plurality of terminals 32 for outputting the electrical signals output from the pixels via through holes 83.

As shown in FIG. 9A, the solid-state imaging unit 81 having the wirings 82 on the bottom surface thereof as thus described may be provided with a protective component 23 (which is identical to the protective component 23 shown in FIG. 3) including a seal glass 24 and a molded resin 25 securing the periphery of the glass. As shown in FIG. 9B, the solid-state imaging unit 81 may be provided with a protective component 51 (which is identical to the protective component 51 shown in FIG. 6) having amounting section 54. As shown in FIG. 9C, the solid-state imaging unit 81 may be provided with a protective component 71 (which is identical to the protective component 71 shown in FIG. 8) obtained by molding a light transmissive member 72 and a frame 73 at a time.

When the solid-state imaging unit 81 having the wirings 82 on the bottom surface thereof is provided with a protective component 23, 51, or 71 as thus described, there is no need for accommodating spaces to be used for wire bonding on the top surface of the solid-state imaging unit 81, and the protective component 23, 51, or 71 can be put in contact with any part of the top surface of the solid state imaging device 81 other than the light-receiving surface. Therefore, the protective components can be designed with improved freedom. When the protective component 51 having the mounting section 54 having an expansion greater than that of the imaging device 22 is used as shown in FIG. 9B, a component greater than the imaging device 22 can be mounted on the mounting section.

It is not essential to perform the processes described above with reference to the flow chart in a time-sequential manner in the order in which the processes are shown in the flowchart. The processes may include a process to be performed in parallel or independently (e.g., a parallel process or object-dependent process).

An embodiment of the present invention is not limited to the embodiment described above, and various modifications can be made within a scope that does not deviate from the gist of the present invention.

The present application contains subject matter related to that disclosed in Japanese Priority Patent Applications JP 2009-148797 and 2009-217717 filed in the Japan Patent Office on Jun. 23, 2009 and Sep. 18, 2009, respectively, the entire contents of which is hereby incorporated by reference.

What is claimed is:

1. A solid-state imaging unit comprising:
an imaging device receiving light at a light-receiving surface thereof; and
a protective component having a light transmissive member covering the light-receiving surface of the imaging device and a frame securing the light transmissive member at the periphery thereof, the protective component being mounted on a peripheral region of the light-receiving surface of the imaging device, wherein
at least the frame is formed using a molding process.

2. A solid-state imaging unit according to claim 1, wherein the protective component includes a mounting section which is formed with a width that is greater at a top end thereof than at a bottom end thereof.

3. A solid-state imaging unit according to claim 2, wherein a lens barrel containing a lens is mounted on the mounting section of the protective component.

4. A solid-state imaging unit according to claim 1, wherein the frame of the protective component has light-blocking properties.

5. A solid-state imaging unit according to claim 1, wherein the protective component is formed as a unitary body by molding a resin to serve as the frame around a seal glass to serve as the light transmissive member.

6. A solid-state imaging unit according to claim 1, wherein the protective component is formed as a unitary body by molding a transparent resin, which is to be used as the light transmissive member, and the frame using two-color molding.
